(19) United States
(12) Patent Application Publication
(10) Pub. No.: US 2005/0038869 A1
(43) Pub. Date: Feb. 17, 2005

(54) Business portal API

(76) Inventors: Randy Zimler, Gainesville, GA (US); Al Hicks, Roswell, GA (US)

Correspondence Address: BAMBI FAIVRE WALTERS, PO BOX 5743, WILLIAMSBURG, VA, 23188, US

(21) Appl. No.: 10/918,029

(22) Filed: Aug. 13, 2004

Related U.S. Application Data
(63) Continuation-in-part of application No. 10/254,183, filed on Sep. 25, 2002.

(51) Int. Cl. G06F 15/16

(52) U.S. Cl. 709/217; 709/245

(57) ABSTRACT

Different communications devices, different communications networks, and/or different users are used to generate, enable, and/or manage a BAPI tool set for providing services through a business communications gateway. The actual physical location of the service and the manner in which it operates are transparent to the user(s).

### CROSS REFERENCE TO RELATED APPLICATIONS

This application is a continuation-in-part of commonly assigned U.S. patent application Ser. No. 10/254,183 entitled “System and Method for Providing Services Access through a Family Home Page,” (Attorney Docket BS02132) filed on Sep. 25, 2002, and of which the “Brief Summary of the Invention” and “Detailed Description of the Invention” sections are incorporated herein by this reference.

This application relates to applicants' co-pending application entitled “API Tool-Set for Providing Services through a Business communications gateway,” (Attorney Docket BS02302) filed simultaneously herewith, and of which the “Brief Summary of the Invention” and “Detailed Description of the Invention” sections are incorporated herein by this reference.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### FIELD OF THE INVENTION

This invention generally relates to providing services to devices on heterogeneous networks. This invention more particularly relates to accessing services through a business portal and to all associated programming interfaces.

### BACKGROUND

Millions and millions of businesses use computer networks to provide access and/or to distribute applications, data files, and other information, to efficiently leverage business and non-business hardware and equipment resources, and/or to provide a communications connection with an “outside network” such as an Internet connection. The needs of each user, however, vary depending on his/her relationship with the business (e.g., employee and job responsibilities, consumer, third party vendor, customer, and so on) and his/her level of comfort with the technology. Ideally, the network recognizes each user as a different and unique user with different capabilities and preferences and provides helpful links especially for that user. Further, the administration of the business communications network requires specialized knowledge that the ordinary user does not have. Therefore, most users of the business communications network do not have the skill or knowledge to correct a problem when it arises. Moreover, users need to access the business communications network from a variety of locations including various on-site communications devices that are typically used by employees as well as various off-site communications devices that may be used by employees and non-employees (also referred to herein as a “third party”).

The user may access the Internet using a graphical browser application of the communications device. Exemplary browser applications include “Navigator” by Netscape Communications Corporation and “Internet Explorer” by Microsoft Corporation. These browsers retrieve graphical Internet pages from the world wide web and present a combination of images, video, and/or audio. Typically, the user may select the web page that is initially displayed each and every time the browser program is launched. This web page is a jumping off point for the user to access other web sites and/or to search the Internet for specialized information. Sometimes, these web pages may be set up as a “portal” to provide user specific links to other web sites. Such a portal is commonly external to the business communications network and consequently is not able to provide assistance and/or interaction with the network's operation. And because many commercial enterprises recognize the advertising potential of “home” pages and/or portals, there are vast numbers of these sites with almost all of them loaded with advertisements.

Sometimes, a business communications network may establish their respective company home page as portal site for Internet users. For example, Microsoft Corporation and specialized service providers such as “ZD Net” offer sites with specialized links targeted towards Internet users that tend to visit and/or access their company home page. However, these sites provide selected links to topics that might interest the user, but these links are not personalized for each user. In addition, the website is completely external to the business communications network and consequently does not assist in the business communications network's creation and/or maintenance. Finally, these websites do not take into account the variety of communications devices that a user may use to gain access to the site nor do they account for the limitations of these communications device (e.g., limited storage space, availability of a video/audio player, and other limitations).

Another approach for Internet users to interface with the business communications network is to choose an Internet service provider (ISP) that allows each account to have several different usernames. Then each user has a unique username, and consequently each user will receive more personalized attention. For example, America Online allows each account to have several different screen names and/or user identities. After a particular user enters a screen name to access the Internet, a beginning page with personalized settings appears. This service is comprehensive for users with only one computer but not for multiple users with multiple computers on a network. Still another weakness of this approach is that although this service limited compatibility with a business communications network, it also does not provide assistance in creating or maintaining that network. As a result, the business must either manage the network or procure management services from another entity.

The current state of business communications network services clearly indicates that a comprehensive system for networking on-site and off-site communications devices for multiple users, providing Internet access and/or business communications network access with personalized settings for multiple users, and providing customized network services to each user (e.g., storing a data file) is needed. Further, there is a need for efficient, personalized interfaces that allow the user to manage and control applications and/or data that is used and/or accessed by the network.

### SUMMARY

This invention provides systems and methods for managing and/or otherwise controlling a broad array of data preferences and/or services through a business communications gateway connecting multiple communications devices and multiple users. According to exemplary embodiments of this invention, a system for providing services includes a business communications network in communication with a service provider network through a business communications gateway. For example, the service provider network may be a telecommunications provider, an Internet Service Provider (ISP), a cable system operator, a data communications network, and/or another third party communications network. A communications device communicates, either directly or indirectly, with the business communications gateway executing on a portal. The portal includes a plurality of links including a link to at least one first data preference and/or service on the business communications network and to at least one second data preference and/or service on the service provider network. To control access, provide flexibility, and enable a distributed business communications network, the system may also include a data store, such as a database and/or dataserver (i.e., integrated database and server), for storing records related to data preferences and/or services for each user associated with the business communications network and/or for a guest user associated with the third party network (e.g., a remote consumer using a communications device to access a data preference and/or service of the business communications network as well as to access a data preference and/or service of the third party network). According to other embodiments of this invention, an applications programming interface manages and associates each communications device in the business communications network (or alternatively, each guest communications device) with at least one available data preference and/or service on the business communications network and with at least one available data preference and/or service on the third party communications network (e.g., the service provider network). Still in further embodiments, a business application services gateway interacts with the applications programming interface to initialize and present the data preferences and/or services to each communications device. In general the Business Applications Programming Interface (“BAPI”) provides an interface whereby a generalized computer program or multiple generalized computer programs are written to manage the user experience, the guest user experience, the business communications gateway (“RG”), and/or the Application Services Gateway(s) (“ASG”).

According to other exemplary embodiments, this invention comprises methods, systems, and apparatus that provide a Business Application Programming Interface (BAPI) that are controlled by a “backend” management system on behalf of a user (and/or a guest user) making requests by and not limited to a standard web interface for a business portal experience. The BAPI embodies a set of control and command options permitting the control of a data source, such as a database, for storing records associated with available services to the user.

In an embodiment of this invention, a user uses a communications device to access a data preference and/or a service. The communications device may comprise any device capable of presenting a user interface, including communications devices capable of displaying visual communications including text, pictures, and other visual material and presenting audio communications including voice, dual tone multi frequency, and other audio communications. A service application may also interface with the communications device. The communications device may be associated with a user registered with the business (e.g., an employee, a vendor, a customer, and so on) or with a guest user who may not be registered or otherwise identified by the business (e.g., a consumer). In either case, the communications device includes some type of processor and a means for communicating with the business communications network and/or business communications gateway.

Any type of data preference and/or service that would be valuable to a user and/or a guest user of the business portal may be provided according to some of the embodiments of this invention. For example, an embodiment may include applications, such as a calendar, a bulletin board, a to-do list, unified messaging, and/or a directory. In addition, applications such as, for example, premise monitoring and security, HVAC control, lighting control, audio distribution, and/or multimedia-on-demand may prove valuable to a user of this invention.

In a method according to an exemplary embodiment of this invention, a computer program executing on a processor, such as a web server, identifies a first data preference and/or service of the business communications network and determines an access address and/or other method for accessing the data preference and/or service. The web server then may create an HTML portal page presenting the data preference and/or service and that may also include a link to the data preference and/or service. The web server also includes a second link to a second data preference and/or service provided by a third party communications network. Since the portal may be provided as an HTML page (or via alternate presentations), the user may access the page from a communications device within a building of the business, a communications device outside the building of the business, and/or a communications device that is in communication with the third party communications network.

Attributes for the data preferences and/or services, the business communications, network, the user, and other relative components of an embodiment of this invention may be stored in a dataserver. The dataserver is in communication with the business communications gateway and may be part of the business communications network, the third party communications network, and/or both. An embodiment includes a mechanism to identify each individual user and to differentiate data preferences and/or service offerings for each user.

Exemplary embodiments of this invention may include computer programs encoded on computer-readable medium, such as volatile and non-volatile storage devices. The computer program code may include scripts, object-oriented components, and/or other types of executable code combined with static elements, such as, for example HTML or extensible markup language (XML) pages and style sheets (XSLT).

Exemplary embodiments of this invention provide numerous advantages over conventional systems and methods. An exemplary embodiment provides a means to integrate a variety of data preferences and/or services accessed by the user (or the guest user) of the business communications network and further provides various mechanisms for controlling access, such as, for example, administrative control to various content. By treating the communications devices within and external to the building of a business as an organizational unit, an embodiment of this invention provides a service provider with an opportunity to differentiate a service offering according to this invention from service offerings provided by the service provider's competitors.

Also, according to exemplary embodiments of this invention, the interface among the business communications network and the third party communications network as well as the location of data preferences and/or services are transparent to the user (and/or the guest user). The business communications network (and/or the service provider) may perform analysis and makes decisions for accessing, executing, interfacing, and/or storing particular data preferences and/or services. The business communications network may then install or assist in installation of the necessary packages and thereafter, create and manage entries in the data preferences and/or services database for each user.

Further details on these embodiments and other possible embodiments of this invention are set forth below. As is appreciated by those of ordinary skill in the art, this invention has wide utility in a number of areas as illustrated by the discussion below. These embodiments may be accomplished singularly, or in combination, in one or more of the implementations of this invention.

### BRIEF DESCRIPTION OF THE FIGURES

The above and other embodiments, objects, uses, advantages, and novel features of this invention are more clearly understood by reference to the following description taken in connection with the accompanying figures, wherein:

FIG. 1 illustrates an operating environment according to exemplary embodiments of this invention;

FIG. 2 illustrates another operating environment according to exemplary embodiments of this invention;

FIG. 3 is a block diagram of a Business Application Programming Interface Module residing in a communications device according to exemplary embodiments of this invention;

FIG. 4 is a flow chart illustrating a process of requesting a data preference and/or service according to exemplary embodiments of this invention;

FIG. 5 is a flow chart illustrating a process of providing a business portal to a user according to exemplary embodiments of this invention;

FIG. 6 is a flow chart illustrating another process of providing a business portal to a user according to exemplary embodiments of this invention;

FIG. 7 is a flow chart illustrating a process for providing selected data preferences and/or services in response to a request from a user according to exemplary embodiments of this invention; and

FIG. 8 is a flow chart illustrating an installation method according to exemplary embodiments of this invention.

### DETAILED DESCRIPTION

This invention now will be described more fully hereinafter with reference to the accompanying drawings, in which exemplary embodiments are shown. This invention may, however, be embodied in many different forms and should not be construed as limited to the embodiments set forth herein; rather, these embodiments are provided so that this disclosure will be thorough and complete, and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, flowcharts, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

As used herein, the term “communications device” includes wired and wireless communications devices, such as a Plain Old Telephone (POTs) phone, a mobile phone, a wireless phone, a Wide Area Protocol (WAP) phone, a satellite phone, a computer, a server, a modem, a pager, a digital music device, a digital recording device, a personal digital assistant, an interactive television, a digital signal processor, and a Global Positioning System device. Further, as used herein, the term “data” includes electronic information, such as, for example facsimile, electronic mail (e-mail), text, video, audio, and/or voice in a variety of formats, such as dual tone multi-frequency, digital, analog, and/or others. Additionally, the data may include: (1) executable programs, such as a software application, (2) an address, location, and/or other identifier of the storage location for the data, (3) integrated or otherwise combined files, such as a grouping of destination communications addresses associated with a receiving party, and/or (4) one or more user profiles and/or preferences associated with a Business Application Programming Interface (BAPI) of this invention. In various embodiments, the data may be stored by a communications network (e.g., the business communications network and/or the third party service provider network), a peripheral storage device connected to a communications network, other connected networks, and/or a communications device.

According to exemplary embodiments, methods and systems of this invention generate, enable, and/or otherwise manage a business application programming interface (BAPI) that seamlessly integrates different communications devices, different communications networks, and/or different users to provide data preferences and/or services through a business communications gateway. According to exemplary embodiments of this invention, the business application programming interface provides a mechanism for accessing a variety of data preferences and/or services, such as, for example, presentation preferences, dynamic communications links, an application interface to control business premise equipment (e.g., lighting, HVAC, security, and so on), an application for a service (e.g., electronic organizer, electronic messaging, word processing, financial management and payment systems, data storage, and so on), and/or others. A user associated with a business communications network may register at least one communications device for a data preference and/or a service, and, then, the registered communications device(s) is provided access and a customized interface according to the data preference and/or service. Alternatively, an administrator of the business communications network may associate multiple communications devices and/or multiple users with a variety of data preferences and/or a service including authorization and privileges to difference communications devices and/or different users to assets of the business communications network. The administrator may thus establish individual privileges of data preferences and/or services for each user and/or for each communications devices. For example, the administrator may register the landline phones of a business address, a first cellular phone of an employee, a Voice over Internet Protocol (VoIP) phone of a vendor, a home computer of a customer, and/or an interactive pager of contractor. Each user of each communications device may be registered for an available service, such as voice messaging over a third party service provider's network. For example, the employee may call an access number (e.g., toll-free phone number, local access phone number, and so on) to logon to the business communications network and/or the third party provider network to retrieve a voice message. The voice message may be (1) a converted text-to-voice message left at an electronic business communications address (e.g., email sent to a work email address) (2) a voice message left at a business communications address (e.g., voice message in employee's mailbox), (3) a voice message left at a personal communications address (e.g., the employee's home phone number), and (4) a converted text-to-voice message left at a personal electronic data communications address (e.g., the employee's personal email account). Still another example is a business computer that allows multiple users within a building of a business to logon to the business communications network and/or third party provider network and to access, execute, and/or otherwise manage data preferences and/or services for each user. However, other embodiments of this invention provide that each user may be associated with a particular communications device for accessing, executing, and/or otherwise managing data preferences and/or services. That is, for example, the user may be able to access video services to the business computer, but not access these video services from a cellular phone.

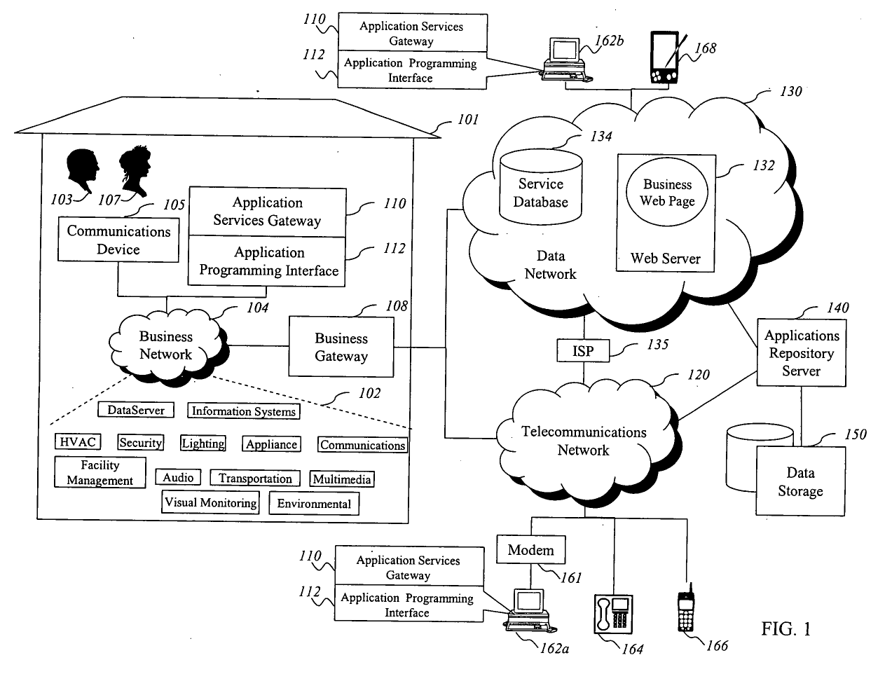

Referring now to the drawings in which like numerals indicate like elements, FIG. 1 illustrates an exemplary environment for operation of embodiments of this invention. The embodiments shown include a business facility 101, a plurality of facility applications 102, a communications device 105 located within the business facility 101 that interfaces with an application services gateway 110 and a Business Application Programming Interface 112, a first user 103, a second user 107, a business network 104, a business communications gateway 108 interfacing with a plurality of external communications networks, shown as telecommunications network 120 and data network 130, and a plurality of remote communications devices, shown as a modem 161 and a computer 162a, another computer 162b, a telephone 164, a cellular phone 166, and a personal digital assistant (PDA). The external communications networks 120, 130 communicate with an applications repository server 140 and a storage server 150. Further, the telecommunications network 120 and the data network 130 may communicate with each other via a connection provided by an Internet Service Provider (ISP), such as America Online, or alternatively, may communicate through a gateway and/or other communications switching components (not shown). Still further, the data network 130 includes a data preference and/or service database 134 (also referred to as the “service database”) and a web server having a business web page 132. Alternatively, the service database 134 may be located within the telecommunications network 120, within another communications network, and/or may be a stand alone component. An embodiment of this invention works to seamlessly provide personalized data preferences and services to the user (and/or a guest user) of the business communications network and/or another communications network and to enable the user (and/or the guest user) to have an association with the business communications network.

The business communications network 104 communicates with the external communications networks 120, 130 through the business communications gateway 108. The business communications gateway 108 includes various components to facilitate networking. For example, in an embodiment utilizing a digital user line (DSL) connection, business communications gateway 108 may include a DSL modem, firewall software, and/or a router. The business communications gateway 108 may also include wide area networking features to allow the user to access components of the business communications network 104 from outside the facility 101.

According to an exemplary embodiment, the application services gateway 110 facilitates an interface with (or, alternatively, execution of) one or more facility applications 102 to the communications device 105 and also facilitates execution of one or more external service applications available via the service database 134, the storage server 150, the telecommunications network 120, the data network 130, another third-party application providers, and/or external communications devices, such as, for example computers 162a and 162b. The applications that interface with and/or on the applications services gateway 110 are available to any communications device that operates both inside the facility 101 (such as communications device 105) and that operates from outside the facility 101 (such as computer 162b). Some examples of the facility applications 102 may include applications such as, information systems (e.g., word processing, group calendars, communications directory, accounting programs, inventory management programs, order processing programs, customer services programs, and so on), a dataserver (i.e., a database and server) application, and other applications that control facility systems including a security application, an HVAC control application, a lighting control application, an audio distribution application, a multimedia-on-demand application, an appliance application, a facility management application, a communications application, a transportation management application, a visual monitoring application, and/or an environmental application. And, the external applications (applications accessible outside of the business network) may include applications similar to the ones within the facility 101 as well as include other applications offered by third party providers and/or otherwise accessible to the user. For example, a telecommunications provider of the telecommunications network 120 may provide a voice messaging application, an internet service provider may provide a text messaging service, an entertainment provider may provide electronic games and/or movies, and/or applications stored in on offsite data services database, such as service database 134. Some further examples of applications may include, bur are not limited to applications for an electronic calendar, a voice messaging application, a text messaging application, a video messaging application, a digital communications application, an electronic to-do list, an electronic directory, a word procession application, a spreadsheet application, a presentation application, a medical application, a research application, a billing application, an accounting application, and others. Still further, the applications may include non-executable data, such as, for example, a data preference for a desktop icon, a communications link, a presentation instruction/preference to the communications device, dynamic settings that change data preferences and service offerings based on scheduling (e.g., time of day, day of week), payment preferences, personalized information (e.g., full name, billing address, shipping addresses, telephone numbers, and so on) that may be selected to automatically populate an electronic form and/or to automatically authenticate the user, and so on.

The business communications gateway 108 connects the business network to the telecommunications network 120 and/or to the data network 130. The telecommunications network 120 may include a public switched telephone network (PSTN), a mobile switching telephone communications network (MSTO), a private branch exchange (PBX), a satellite communications network, and/or other networks. For example, in an embodiment in which the telecommunications network 120 includes a DSL network, the business communications gateway 108 may include a DSL modem (not shown) and connect to a digital user line access multiplexer (DSLAM) in a central office (not shown) of the telecommunications network 120 via a local telephone loop. According to other embodiments, the telecommunications network 120 may be operated by a regional bell operating company. The telecommunications provider performs various tasks, including downloading applications, updating applications and data, maintaining control programs, and allowing third-party access to services within and/or services managed or otherwise controlled by the telecommunications network 120. Still further, the data network 130 may include a world wide electronic data communications network, such as an Intranet, an Internet, an Extranet, and/or a stand alone server or other computing device. And, still in further embodiments, this invention may use a hybrid network, such as if the communications device 105 is embodied as a Voice over Internet Protocol (VoIP) communications device that communicates with both the telecommunications network 120 and the data network 130

Also in communication with the business communications network 104 and the telecommunications network 120 is a web server 132 having the business web page 132 and the services database 134. The web server 132 responds to requests, such as hypertext transfer protocol (HTTP) requests, with documents, such as hypertext markup language (HTML) documents. Further, the service database 134 may be an Oracle, Microsoft SQL Server, and/or any other database that stores information necessary to provide data preferences and/or services to the user. The web server 132 may also provide applications executing under a common gateway interface (CGI), Microsoft Active Server Pages (ASP), or other environment. The web server 132 may include various applications, such as a portal service.

In an exemplary embodiment of this invention, the user may use a variety of means to access data preferences and/or services provided by the business communications gateway 108, such as using a variety of communications devices 105, including a POTS phone, a mobile phone, a wireless phone, a WAP phone, a satellite phone, a computer, a server, a modem, a pager, a digital music device, a digital recording device, a personal digital assistant, an interactive television, a digital signal processor, and/or a Global Positioning System device, to access one or more of the business network 104, the telecommunications network 120, the data network 130, and/or another third party network. Further, the Business Application Programming Interface (BAPI) 112 controls and manages each user's communications with the networks and to available applications. That is, BAPI 112 controls the available data preferences, services, and/or applications to a communications device 105 for the first user 103 and controls the available data preferences, services, and/or applications to the same communications device 105 for a second user 107, so that each user has a personalized business portal over the business communications network 104, the telecommunications network 120, the data network 130, and/or another third party network.

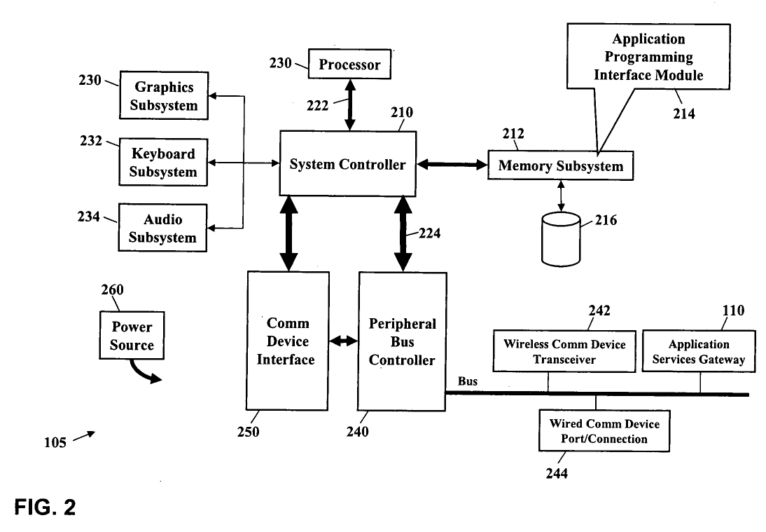

FIG. 2 is a block diagram showing a Business Application Programming Interface Module 214 that operates within a system memory device 212 of a communications device 105 according to an exemplary embodiment. The Business Application Programming Interface Module 214, however, could also reside in flash memory, a peripheral storage device 216, and/or an alternate communications device (such as, for example, computers 162a, 162b, cellular phone 166, and PDA 168). As illustrated, the communications device 105 also includes and/or interfaces with one or more central processors 220 executing an operating system. The operating system, as is well known, has a set of instructions that control the internal functions of the communications device 105. A system bus 222 communicates signals, such as data signals, control signals, and address signals, between the central processor(s) 220 and a system controller 210. The system controller 210 provides a bridging function between the memory subsystem 212, the one or more central processors 220, a graphics subsystem 230, a keyboard subsystem 232, an audio subsystem 234, a PCI (Peripheral Controller Interface) bus 224, and a Communications (“Comm”) Device Interface 250. The PCI bus 224 is controlled by a Peripheral Bus Controller 240. The Peripheral Bus Controller 240 is an integrated circuit that serves as an input/output hub for various peripheral ports and/or transceivers. These peripheral ports allow the communications device 105 to communicate with a variety of other communications devices through networking ports (such as SCSI or Ethernet) that include Wireless Communications (“Comm”) Device Transceiver 242 (such as Wireless 802.11 and Infrared) and Wired Communications (“Comm”) Device Port/Connection 244 (such as modem V90+ and compact flash slots) and to communicate with the applications service gateway 110 to execute the available applications. These peripheral ports could also include other networking ports, such as, a serial port (not shown) and/or a parallel port (not shown). The Comm Device Interface 250 allows the communications device 105 to monitor, detect, receive, and decode incoming communications signals to the communications device(s) connected to the Wireless Comm Device Transceiver 242 and/or the Wired Comm Device Port/Connection 244. Further, the Comm Device Interface 250 communicates and/or transmits communications signals to the Wireless Comm Device Transceiver 242 and/or the Wired Comm Device Port/Connection 244. Still further, the communications device 105 may include a power source 260, such as a rechargeable battery to provide power and allow the communications device 105 to be portable. In alternate embodiments, the communications device 105 could include its own telephone line (or other communications connection) to the business network 104 and/or to the telecommunications network 120.

The system memory device (shown as memory subsystem 212 or peripheral storage device 216) may also contain one or more application programs. For example, an application program may cooperate with the operating system and with a video display unit (via graphics subsystem 230) to provide a GUI for the Business Application Programming Interface Module 214. The GUI typically includes a combination of signals communicating with the graphics subsystem 230 and/or the keyboard subsystem 232. The GUI provides a convenient visual and/or audible interface with the user of the communications device 105. As is apparent to those of ordinary skill in the art, the user (and/or guest user) interacts with the Business Application Programming Interface Module 214 over a variety of mediums, such as, for example, a stylus, keyboard, and punch buttons of the keyboard subsystem 232, a display screen of the graphics subsystem 230, and/or a voice-activated menu prompt of the audio subsystem 234.

According to exemplary embodiments of this invention, the BAPI Module 214 includes information needed to customize the availability and access of each user 103, 105 for each associated communications device (e.g., 105, 162a, 162b, 164, 166, and/or 168) for each of the networks (e.g., 104, 120, and 130). For example, each of the users 103, 105 may be identified as employees (and/or other affiliates) of the business such that each user 103, 105 has an account associated with the personal name and/or other identifiers of the business for the portal service, such as, account number, user code, last name, first name, middle name, and/or title. Further, the business portal may be associated with a business address and other business information, such as, street address, other address, city, state, zip code, employee directory, products and/or services, customer information, and so on. Still further, the business may also establish an account for each user of the business portal to manage and/or otherwise gather billing information, such as, for example, user identification information, account number, telephone number, billing strategy, billing amount, and billing date information. For each user 103, 150 (and each guest user), the BAPI may associate personal account information of each user 103, 105 with some of the business portal information, for example, the user 103 may have a personal account with his/her name that is associated with a communications address and categorization (e.g., employee, customer, vendor, and so on), account number, user code, and/or available data preferences and/or services for that user 103 via the portal.

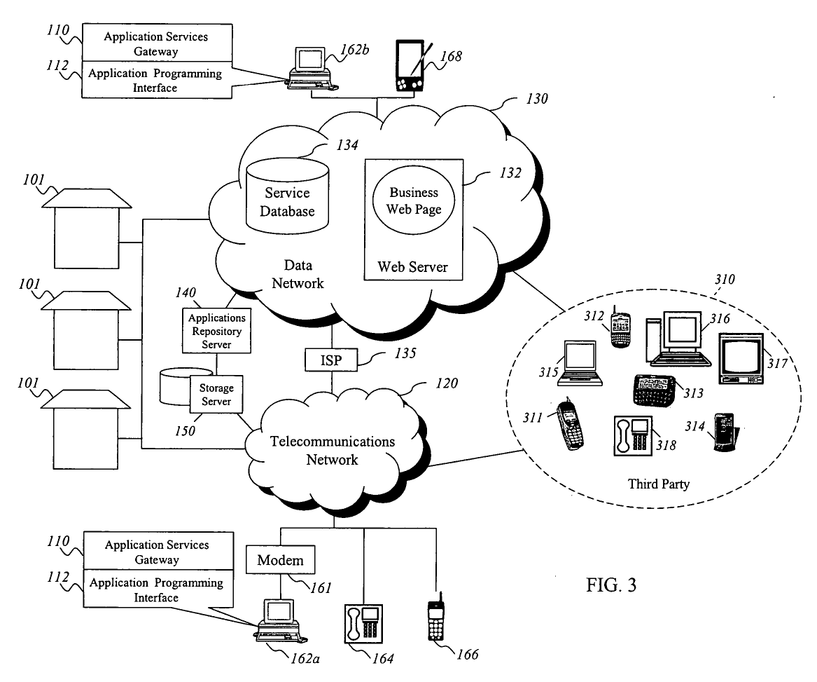

FIG. 3 illustrates an operating environment similar to the operating environment of FIG. 1; however, the operating environment of FIG. 3 further includes various communications devices 310 for accessing, interfacing, executing, and/or otherwise managing data preferences and services of a guest user. These communications devices 310 are illustrated as a cellular phone 311, a VoIP phone 312, a pager 313, a personal digital assistant (PDA) 314, a laptop computer 315, another computer 316, and/or an interactive television 317. Alternatively, the guest user may use any communications device having a digital signal processor to provide the business portal. Typically, the guest user may be a consumer who requests temporary access to the business portal for informational purposes and/or for communications with the user (e.g., user 103, 105 of FIG. 1).

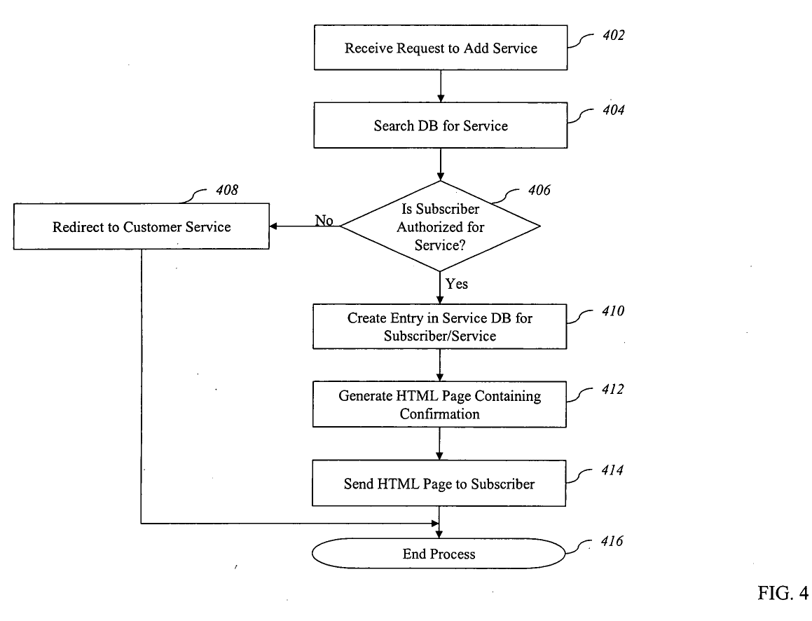

FIG. 4 illustrates a process of requesting a service according to exemplary embodiments of this invention. Requesting a data preference and/or service (including an application), which is also referred to as registering for a service, may entail calling a service representative, mailing in a subscription form, or filling out a form via a web browser and/or web server. In the process shown, a communications service provider (e.g., telecommunications service provider, Internet (data communications) service provider, and others) receives a request from a user to add a service [block 402]. For example, the user may wish to take advantage of a backup service. In response to receiving the request, a program executing on the web server searches the service database [block 404] for services that the user has registered for or that the user is authorized to use. The services database 134 may alternatively communicate with the user's communications device sending the request and, thus, not necessitate the web server. For example, the user's communications device may communicate profile data associated with the user and communicate the profile data to the web server. Using the profile data, the web server next determines whether or not the user is authorized for the requested service [block 406]. In the embodiment shown, if the program executing on the web server determines that the user does not have authorization, the web server redirects the user's request to, for example, customer service [block 408]. A customer service representative or automated program may then provide instructions to the user for gaining access.

Alternatively, the business (via an administrator or alternate authorized individual) may designate a destination for unauthorized service requests to be redirected. For example, the business may designate certain adult-oriented services as blocked from users. Another example may be that the business may designate certain confidential information (e.g., trade secret, billing and accounting, and other sensitive information) as available only to selected users, and, thus, blocked by other users. In addition, the business portal may automatically encrypt or otherwise secure this restricted information, such that only a communications device registered with the personal account as well as personal identification by the user may decode the sensitive information. The business may further designate a page, explaining restrictions and/or business portal limitations, as the destination for requests that the web server determines are not authorized to access the blocked sites. When an unauthorized user attempts to access the restricted or otherwise limited service (including applications and/or data preferences), the web server redirects the request to the designated page.

If the user is authorized, then the web server creates an entry in the service database for the user, service combination [block 410]. For example, if an authorized user wishes to access accounting information and services, then the web server searches the service database to determine whether the business has put any limits on access to the accounting information and services (e.g., permission to search by a particular account identifier but not authorized for all accounting information). If the business has not limited access to the data preferences and/or services on the portal and if there are no other limitations on who may access the service, then the web server creates an entry linking the service with the user so that a link to the service appears on the user's portal page.

Referring again to FIG. 4, the web server may further generate an HTML page containing a confirmation of access to the data preference and/or service [block 412]. The HTML page may contain additional information, including any usage instructions or other pertinent information. The web server next sends the HTML page to the user [block 414], and the process ends [block 416].

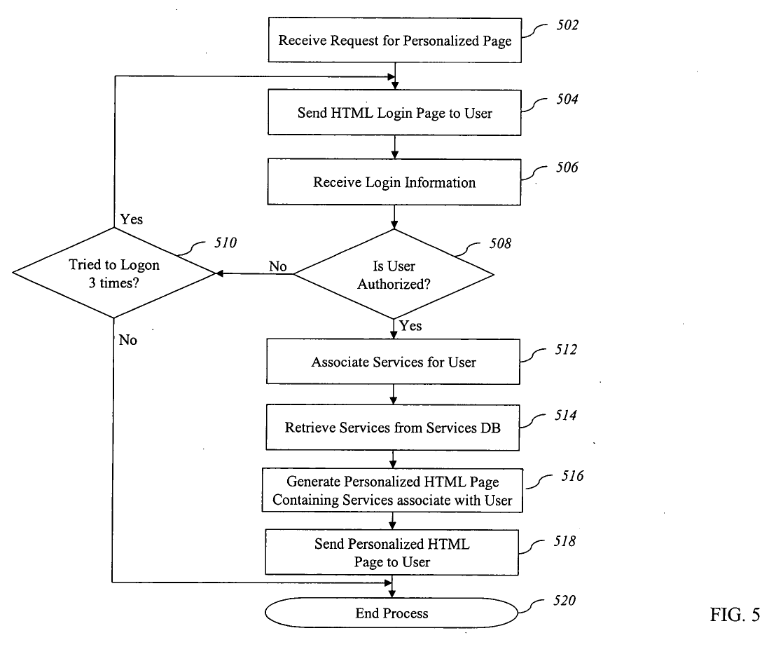

FIG. 5 is a flow chart illustrating a process of providing a personalized page to a user according to exemplary embodiments of this invention. In the process shown, the web server receives a request for a personalized page from the user [block 502]. A personalized page contains links and other content previously specified by the user during a registration or other process or set up as default content by the service provider. In response to the request, the web server sends an HTML page containing a login form to the user via the business communications gateway [block 504]. The user fills in the login information and submits the form to the web server. The web server receives the login information [block 506]. In other embodiments, the login process is automated. In such an embodiment, the web server sends the HTML page with the login as illustrated, and an automated process executing on the business communications gateway or other processor within the home responds by sending the login information to the web server. For example, the username and password may exist in a cookie. The business communications gateway uses the cookie to provide the login information.

The web server verifies that the user is authorized to access the personalized page [508. If the authorization fails, then the web server may allows additional attempts [block 510]. If the attempts fail, then the process ends [block 518]. If the authorization is successful, then web server retrieves data preferences and/or services (including applications and other electronic information) for the user from a database accessible by the portal (e.g., the services database 134 of FIG. 1) [block 512]. In an embodiment of this invention, the data preferences and/or services includes a variety of individual data elements. These data elements identify the data preference and/or service type, a location that the data preference and/or service executes (if it executes), and additional parameters necessary to provide the data preferences and/or service to the user. For example, in one embodiment of this invention, the database/server includes a uniform resource locator pointing to a calendar web site on the web server allowing the user to view his/her calendar along with other calendar's (if the user has access to another calendar). In another embodiment, the database/server includes a reference to a backup program that is installed on each computer in the facility and is operable for backing up data from the computers to a data storage device associated with either a remote network and/or a third party provider network.

The web server utilizes the data preference and/or service information to generate an HTML page according to the data preferences and that also contains links to various services available to the user [block 514]. In addition, another user (e.g., another authorized employee, vendor, and/or guest user) may also simultaneously log in and access his/her data preferences and/or services available via the business portal. The web server then sends the resultant HTML page to each user [block 516]. The process then ends [block 518].

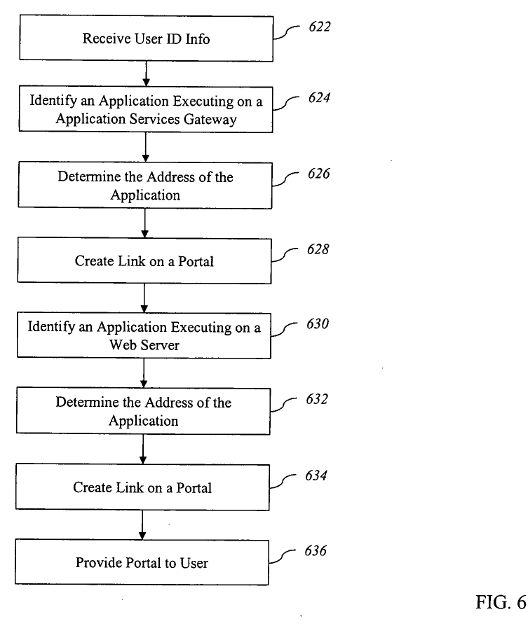

FIG. 6 is a flow chart illustrating exemplary embodiments of this invention for processing user identification information to create the personalized business portal for the user. In the process shown, the web server receives user identification information, such as a username/password combination [block 602]. Alternatively, the user's communications device may automatically communicate personalized profile information to the web server when a communications connection is established. In response, the web server searches the database/server and identifies a data preference, service, application, and/or other electronic information that is provided and/or that executes on the business communications gateway [block 604]. The actual data and/or executable code may reside elsewhere in the business communications network and/or a third party provider network, however, the data communicates with and/or the code executes on the processor on the business communications gateway. The web server next determines the address of the service and/or application based on the data retrieved from the database/server [block 606]. For example, the data retrieved from the database/server may include the Internet protocol (IP) address of the business communications gateway as well as an executable name. Alternatively, the business communications gateway may include web server software. In that case, the data may include the IP address and a web location in the form of a uniform resource locator (URL). For example, in one embodiment the business communications gateway is a dynamic host configuration protocol (DHCP) server to computers within the business facility as well as a DHCP client to the provider network. In such an embodiment, the business communications gateway has an internal address, such as 192.168.0.1, in the internal network. The database/server includes the internal address and the name of the web site, for example, 192.168.0.1\WebSiteName. The web server includes a program, such as an ASP program, that creates a portal page. When the web server retrieves the information about the application that executes on the business communications gateway, the web server creates a link on the portal page that links to the web site on the business communications gateway [block 608].

The web server may identify multiple data preferences and/or services that the user has access. In the embodiment shown, the web server identifies a second application that executes on the web server itself [block 610]. The web server determines the address (of itself) from the data retrieved from the database/server [block 612] and creates a link to the address on the portal page [block 614]. The web server then provides the business portal to the user via the business communications gateway [block 616].

According to exemplary embodiments of this invention, once the user is presented with the web page customized with data preferences and/or containing links to services, the user accesses those data preferences and/or services. The services may execute on any of the various available platforms illustrated in FIG. 1. Execution of a service may occur on multiple components and may vary over time. For example, a service for providing the user with a way to organize contacts, including names, addresses, and phone numbers, may include a database and a user interface executing on the business application services gateway 110. Later, the business and/or a third party service provider may determine that it is more efficient to save all users' databases of contacts on a database within a telecommunications network (or alternatively, the data network or another database) but continue to execute the business applications programming interface and the application services gateway 110 to ensure acceptable response times. The business and/or provider can accomplish the movement of the application and corresponding references to the application in a number of ways. For example, the business and/or provider can manually change the links on various web pages to point to the relocated database. Alternatively, the business and/or service provider may create a database of services, such as service database 134 of FIG. 1 that allows the business and/or the provider to simply make changes to records in the database when the location or operation of a service is changed.

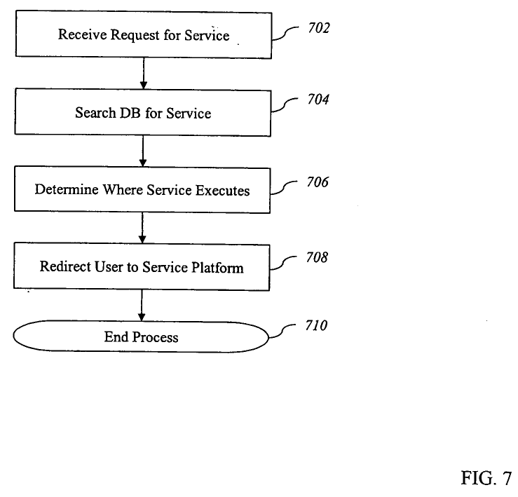

FIG. 7 is a flow chart illustrating a process for responding to requests for services from a user according to an exemplary embodiment of this invention. The process illustrated by FIG. 7 may be carried out on any of the computer platforms illustrated in FIGS. 1 and/or 3. In one embodiment, the business communications gateway 108 executes the process. When the user views the HTML page that contains links to services, the user selects a service by clicking on the corresponding hyperlink. As a result of the user's selection, the business communications gateway receives a request for a data preference and/or service from the user via a communications device [block 702]. The business communications gateway searches an internal or external database for the entry corresponding to the user's request [block 704]. The database returns a record that contains information related to the data preference and/or service. Using this record, the business communications gateway determines on which platform the application is stored and/or executes [block 706]. For example, the record may contain the IP address or server name and the name of an executable or other program file. The business communications gateway utilizes this information to redirect the user's request for data preference and/or service to the platform that provides the data preference and/or service [block 708]. Since the application may reside and/or execute on the business communications gateway itself, redirection also encompasses handling the request via an executable on the same machine that receives the request. Once the user's request has been redirected, the process ends [block 710].

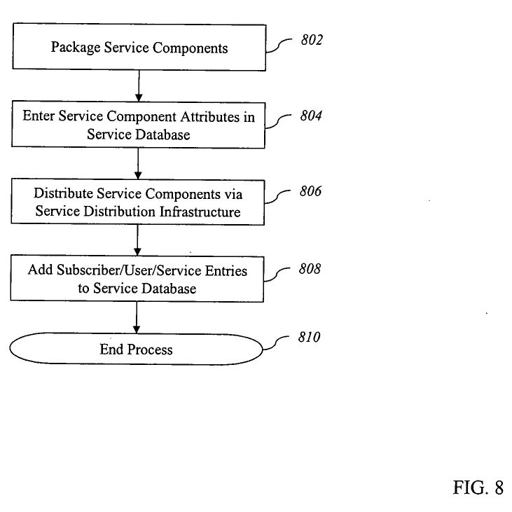

Exemplary embodiments of this invention include administrative tools for business and/or the service provider. For example, the business and/or service provider may use a variety of methods for installing applications within the business network and/or the service provider's network. It may be more difficult to install components within the business, so some components may be stored to the provider's network. In order to perform these installations, the service provider has three basic options: (1) the user and/or authorized user performs the install; (2) the service provider sends someone to the user's facility to perform the install; or (3) the service provider installs the components remotely. FIG. 8 is a flow chart illustrating a method of installing the components remotely in an exemplary embodiment of this invention. In the embodiment shown, the service provider creates packages for distributing the components of a particular service [block 802]. The term “package” is to be defined broadly. For example, a package may comprise a cab (cabinet) file or some other type of self-extracting file. A package may also comprise information stored in a software distribution product, such as Microsoft's System Management Server (SMS). Software distribution products automate the process of distributing software across both homogonous and heterogeneous networks.

In the embodiment shown in FIG. 8, the provider next enters service component attributes in the service database [block 804]. The business communications gateway uses these attributes to determine where to direct user requests. Once the package has been created, the service provider distributes the components via a service distribution infrastructure [block 806]. The infrastructure includes the automated software distribution system, if present, along with any necessary software and/or hardware for distributing and installing the components. In the embodiments shown, the user cannot access the data preference and/or the service until the service provider (or the business) authorizes that user. In order to authorize the user to utilize a particular service, the service provider adds a user-service relationship entry to the service database [block 808]. The business communications gateway searches for the user-service entry whenever a user requests a particular service.

In exemplary embodiments of this invention, the business and/or the service provider has numerous opportunities to add value for a user. Consequently, the business and/or provider has various options for deriving revenue from the installation, recapturing installation costs, provisioning, and support of the various services. For example, a business and/or provider may charge the user a monthly charge for each registered service. The business and/or service provider may also charge the user a monthly charge for equipment rental for the business communications gateway, application services gateway, and other components present in an embodiment. In addition, the business and/or service provider may establish a minimum service contract period whereby the user is penalized for an early termination.

In addition, the business and/or the service provider may derive revenue from other ssources, such as third-party application and content service providers. If the business and/or service provider of the network and infrastructure provides a mechanism for users to access a third-party service, the business and/or the service provider may charge the third party for providing the mechanism. The third party, in turn, charges the users for accessing the service.

While several exemplary implementations of embodiments of this invention are described herein, various modifications and alternate embodiments will occur to those of ordinary skill in the art. For example, the next generation “softswitch” in the telecommunications industry simply replaces a service control point (SCP) with an “application server.” This application server is a conventional computer server that also includes triggers for telecommunications services so that “new entrants” into telecommunications services (e.g., new telecommunications service providers) don't have to purchase expensive hardware and equipment to process telephone communications. This next-generation packet network represents an alternative operating environment for the systems, methods, programs, and apparatuses of this invention. Here the telecommunications switch includes a packet-based “softswitch.” This “softswitch” uses software control to provide voice, data, and video services by dynamically changing its connection data rates and protocols types. An application server interfaces with the “softswitch” via a packet protocol, such as Session Initiation Protocol (SIP). This application server includes voice service protocols, triggers, and operations that allow the business communications network 104, the telecommunications network 120, and/or the data network 130 of FIG. 1 to interoperate. Accordingly, this invention is intended to include those other variations, modifications, and alternate embodiments that adhere to the spirit and scope of this invention.

1. A method for managing network-based access to computer data preferences comprising:
associating a first data preference with a user, the first data preference comprising at least one electronic data file executing in a first communications network;
associating a second data preference with the user, the second data preference comprising at least one electronic data file executing in a second communications network;
determining a first access address of the first data preference;
determining a second access address of the second data preference; and
providing access to the first access address via a first link on a portal accessible through a business communications gateway;
providing access to the second access address via a second link on the portal accessible through the business communications gateway,
wherein a Business Application Programming Interface in communication with the business communications gateway associates the user with the first data preference and with the second data preference.

2. The method of claim 1, further comprising:
receiving an identifier of the user; and
authenticating the user.

3. The method of claim 2, further comprising:
receiving an identifier of a guest user;
authenticating the guest user;
associating a first guest data preference with the guest user;
determining a first guest access address of the first guest data preference; and
providing access to the first guest access address via a first guest link on the portal.

4. The method of claim 3, further comprising:
associating a second guest data preference with the guest user;
determining a second guest access address of the second guest data preference; and
providing access to the second guest access address via a second guest link on the portal.

5. The method of claim 1, further comprising:
providing a registration user interface for adding an access address for an available data preference from the portal, the registration user interface having at least one selective available data preference for the user.

6. The method of claim 1, wherein the first communications network comprises a business communications network of one or more communications devices associated with the user.

7. The method of claim 1, wherein the second communications network comprises a third party communications network.

8. The method of claim 6, further comprising:
providing remote access to the portal from at least one of the communications devices, the remote access from a location outside a dwelling of the business address.

9. The method of claim 1, further comprising:
providing electronic storage of at least one of the first data preference and the second data preference on a data store remote from the business address.

10. A storage medium on which is encoded instructions for managing network-based access to personalized data preferences, including instructions for performing the steps of:
associating a first data preference with a user, the first data preference comprising at least one electronic data file executing in a first communications network;
associating a second data preference with the user, the second data preference comprising at least one electronic data file executing in a second communications network;
determining a first access address of the first data preference;
determining a second access address of the second data preference; and
providing access to the first access address via a first link on a portal accessible through a business communications gateway;
providing access to the second access address via a second link on the portal,
wherein a Business Application Programming Interface in communication with the business communications gateway associates the user with the first data preference and with the second data preference.

11. The storage medium of claim 10, further comprising instructions for:
receiving an identifier of the user;
authenticating the user;

12. The storage medium of claim 10, further comprising instructions for:
receiving an identifier of a guest user;
authenticating the guest user;
associating a first guest data preference with the guest user;
determining a first guest access address of the first guest data preference; and
providing access to the first guest access address via a first guest link on the portal.

13. The storage medium of claim 12, further comprising instructions for:
associating a second guest data preference with the guest user;
determining a second guest access address of the second guest data preference; and
providing access to the second guest access address via a second guest link on the portal.

14. The storage medium of claim 10, further comprising instructions for:
providing a registration user interface for adding an access address for an available data preference from the portal, the registration user interface having at least one selective available data preference for the user.

15. A system for managing network-based access to computer data preferences comprising:
a business communications gateway in communication with a first communications network and a second communications network, wherein the first communications network comprises a business communications network of at least one registered communications device and the second communications network comprises a third party communications network;
a portal communicating with the at least one registered communications device, wherein the portal comprises:
a first link to a first data preference available on the first communications network, and
a second link to a second data preference available on the second communications network; and
a Business Application Programming Interface in communication with the business communications gateway, the Business Application Programming Interface managing access to the first data preference and the second data preference.

16. The system of claim 15, wherein the at least one registered communications device comprise at least one of:
a telephone,
a wireless communications device,
a mobile phone,
a wireless phone,
a WAP phone,
a satellite phone
a computer,
a server,
a modem,
a pager,
a digital music device,
a digital recording device,
a personal digital assistant,
an interactive television,
a digital signal processor, and
a Global Positioning System device.

17. The system of claim 15, the second communications network comprises a world wide electronic data communications network having at least one of an internet, an intranet, or an extranet accessible to the portal.

18. The system of claim 15, wherein the second communications network comprises at least one of a telecommunications network and a voice over internet protocol network.

19. The system of claim 18, wherein the telecommunications network comprises at least one of a private branch exchange, a public switched telephone network, a mobile switching telephone communications network, and a satellite communications network.

20. The system of claim 15, wherein the second communications network comprises a data storage device.
